(19) United States
(12) Patent Application Publication
(10) Pub. No.: US 2011/0072752 A1
(43) Pub. Date: Mar. 31, 2011

(54) SHINGLE WITH INCREASED THICKNESS OF SEALANT

(76) Inventors: David P. Aschenbeck, Newark, OH (US); Leslie D. Vazquez-Serrano, Pataskala, OH (US)

(21) Appl. No.: 12/569,479

(22) Filed: Sep. 29, 2009

(51) Int. Cl. E04D 1/26; E04D 1/36; E04D 1/12; B65B 35/56; B05D 1/12

(52) U.S. Cl. 52/543; 53/446; 427/186

(57) ABSTRACT

Roofing shingles have a top surface, a bottom surface, a headlap portion, and a bead of tab sealant that is configured to bond to an underlying shingle when the shingle is applied on a roof. The tab sealant has a thickness that causes it to extend beyond a face of the bottom surface of the shingle. The headlap portion has a depression extending horizontally across the shingle when shingle is applied to the roof, the depression being spaced from a top edge of the shingle by a distance that will allow the depression to be aligned with the tab sealant of a complementary shingle when the shingles are assembled in complementary pairs, back to back in a bundle.

### BACKGROUND

Typical asphalt-based roofing shingles include a roofing mat with asphalt and covered with a layer of roofing granules. The shingles include a prime portion that is exposed when the shingles are installed on a roof and a headlap portion that is covered by the upper adjacent course of shingles when the shingles are installed on a roof. Laminated roofing shingles also include an underlay made from a second asphalt-coated mat and positioned beneath the prime portion of the shingles.

A common type of laminated shingle includes an overlay having tabs and cutouts in the exposed portion of the shingle, and an underlay adhered to the bottom of the overlay below the tabs and cutouts. The laminated shingle includes laminated or double-layered portions where the overlay and underlay overlap, and non-laminated or single-layered portions where they do not overlap. The laminated portions include the areas of the tabs, and a longitudinal central area of the shingle between the inner ends of the cutouts and the inner end of the underlay. The non-laminated portions include the area of the shingle that does not include the underlay.

Asphalt shingles generally include a sealant bead to hold down the tabs of the shingle when the shingles are installed on a roof. The tab sealant can be positioned on the top of the shingle for bonding to the tab of the next overlying shingle, or can be positioned beneath the tab portion of the shingle to bond the tab portion to a shingle in the previously laid course of shingles.

Subsequent to manufacturing the roofing shingles, the laminated shingles are packaged in a stack or bundle of shingles. The laminated shingles are generally stacked back to back by turning every other shingle 180° relative to the adjacent shingles. This stacking method generally minimizes uneven build in the bundle caused by the difference in thickness between the area of the shingle that includes the underlay and the area that does not include the underlay. In some instances, the pressure is exerted on the tab sealant in the pallet, because the tab sealant becomes the high point. This pressure can cause the sealant to be flattened, thereby lessening the effectiveness of the tab sealant to hold down the shingle tabs when the shingles are installed on the roof.

It would be desirable to have an improved shingle and process for making the shingle.

### SUMMARY

In accordance with embodiments of this invention there are provided roofing shingles having a headlap portion, a tab portion, a granulated top surface and a bottom surface. The bottom surface of the shingles includes a bead of tab sealant extending horizontally across the shingles when the shingles are applied to a roof. The tab sealant has a thickness that causes the tab sealant to extend beyond a face of the bottom surface, and is configured to bond to an underlying shingle when the shingles are applied on a roof with other similar shingles in courses. The granulated top surface has a depression in the headlap portion extending horizontally across the shingles when the shingles are applied to the roof. The depression is spaced from a top edge of the shingles by a distance that will allow the depression to be aligned with the tab sealant of complementary shingles when the shingles are assembled in complementary pairs, back to back in a bundle.

In accordance with other embodiments, there are also provided roofing shingles having a headlap portion, a tab portion, a granulated top surface and a bottom surface. The bottom surface of the shingles includes a bead of tab sealant extending horizontally across the shingles when the shingles are applied to a roof. The tab sealant has a thickness that causes the tab sealant to extend beyond a face of the bottom surface, and is configured to bond to an underlying shingle when the shingles are applied on a roof with other similar shingles in courses. The granulated top surface has a depression in the headlap portion extending horizontally across the shingles when the shingles are applied to the roof. The depression is formed of fine granules having a diameter smaller than a remainder of the granules of the granulated top surface.

In accordance with other embodiments, there are also provided methods for packaging roofing shingles in a bundle. The methods include the steps of making shingles having a headlap portion, a tab portion, a granulated top surface, a bottom surface, and a depression, and further including a bead of tab sealant on the bottom surface, wherein the depression and tab sealant extend horizontally across the shingles when the shingles are applied to a roof. The methods further include assembling the shingles in complementary pairs back to back in a bundle, wherein the depression of each shingle is aligned with the tab sealant of its complementary shingle in the bundle.

In accordance with other embodiments, there are also provided methods for making roofing shingles having a headlap portion, a tab portion, a granulated top surface, a bottom surface, and a bead of tab sealant which extends horizontally across the shingles when the shingles are applied to a roof. The methods include applying asphalt to a shingle mat to form an asphalt-coated sheet. The methods further include applying fine granules to a portion of the asphalt-coated sheet, the portion being configured to extend horizontally across the shingle when the asphalt-coated sheet is made into a shingle and the shingle is installed on a roof. The methods further include applying headlap and prime granules to a remainder of the asphalt-coated sheet, thereby forming the granulated top surface, the headlap and prime granules being larger in diameter than the fine granules, thereby forming a depression in the granulated top surface at the portion of the asphalt-coated sheet having the fine granules.

In accordance with embodiments of this invention there are provided roofing shingles having a headlap portion, a tab portion, a granulated top surface and a bottom surface. The bottom surface of the shingle includes a bead of tab sealant extending horizontally across the shingle when the shingle is applied to a roof. The tab sealant has a thickness that causes the tab sealant to extend beyond a face of the bottom surface, and is configured to bond to an underlying shingle when the shingle is applied on a roof with other similar shingles in courses. The bottom surface has a depression in the headlap portion extending horizontally across the shingle when the shingle is applied to the roof. The depression is spaced from a top edge of the shingles by a distance that will allow the depression to be aligned with the tab sealant of a complementary shingle when the shingles are assembled in complementary pairs, back to back in a bundle.

Various advantages of this invention will become apparent to those skilled in the art from the following detailed description of the invention, when read in light of the accompanying drawings.

### BRIEF DESCRIPTION OF THE DRAWINGS

FIG. 1 is a schematic view in elevation of an apparatus for manufacturing asphalt-based roofing shingles according to an embodiment of the invention.

FIG. 2 A is a side view of a complementary pair of laminated roofing shingles showing the alignment of tab sealants with depressions formed of fine granules in the headlap portion of the granulated top surface.

FIG. 2B is an enlarged view of the shingle of FIG. 2A.

FIG. 3 is a side view of a complementary pair of laminated roofing shingles showing the alignment of tab sealants with depressions formed on the bottom surface underneath the headlap portion according to an embodiment of the invention.

FIG. 4 is a schematic top view of a granule applicator making two-wide shingles having portions of fine granules deposited on the headlap portion of the shingles.

FIG. 5 is a cross-sectional, enlarged view of the rollers shown in FIG. 1 used to create a depression according to embodiments of the invention.

FIG. 6 is a side cross-sectional view of a bundle of laminated roofing shingles according to embodiments of the invention stacked back to back showing the alignment of the depressions with the tab sealants of the complementary shingles to reduce pressure exerted on the tab sealants in the bundle.

### DETAILED DESCRIPTION

The present invention will now be described with occasional reference to the specific embodiments of the invention. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

In accordance with embodiments of the present invention, roofing shingles specially configured to enable the tab sealant to maintain its thickness and height and not flatten out when the shingles are assembled in complementary pairs, back to back in a bundle, are provided. Also, methods for packaging roofing shingles in a bundle so that the sealant bead maintains its thickness and height and does not flatten out when the shingles are assembled in complementary pairs, back to back in a bundle, are provided. In a particular embodiment, the use of fine granules in a stripe on the granulated surface of the headlap portion opposite the release surface provides about 15-20 mils of reduced thickness for the tab sealant on the complementary shingle in the bundle, thereby reducing compression or spreading of the sealant bead. It is contemplated that this results in an increase of the sealant thickness at installation and improves bonding of the sealant to the underlying shingle in the previous course of shingles on the roof. It will be understood the term “alignment” refers to the tab sealant and depression being aligned within 10 mm of each other when the shingles are assembled in complementary pairs, back to back in a bundle. Alternatively, the term “alignment” refers to the vertical alignment of the tab sealant and depression at their respective center points when the shingles are assembled in complementary pairs, back to back in a bundle. The term “granules” as used herein, is defined to mean fine, headlap and prime granules unless otherwise specified. The term “asphalt coating”, as used herein, is defined to mean any type of material appropriate for coating a roofing material, including, but not limited to bituminous materials including asphalts, tars, pitches, and mixtures thereof. The term “depression” as used herein, is defined to mean any groove, indentation, recess, and the like, that assists the sealant bead to maintain its thickness and height when the shingles are assembled in complementary pairs, back to back in a bundle. The term “mat”, as used herein, is defined to mean any type of material known for use in reinforcing asphalt-based roofing materials, including, but not limited to a web, scrim or felt of fibrous materials such as mineral fibers, cellulose fibers, rag fibers, mixtures of mineral and synthetic fibers, and the like.

The description and figures disclose roofing shingles configured in such a manner so that the sealant bead is more likely to maintain a significant portion of its thickness and height when the shingles are packaged in a bundle. Such a sealant bead will have less of a tendency to flatten out when the shingles are assembled in complementary pairs, back to back in a bundle. Further disclosed are methods for packaging roofing shingles in a bundle so that the sealant bead maintains its thickness and height and flattens out less when the shingles are assembled in complementary pairs, back to back in a bundle. Further disclosed are methods for making roofing shingles configured in such a manner so that the sealant bead is more likely to maintain a significant portion of its thickness and height when the shingles are packaged in a bundle. For ease of discussion herein, the prime region of the roofing shingles will be generally referred to as the tab portion.

Composite shingles, such as asphalt shingles, are a commonly used roofing product. Asphalt shingle production generally includes feeding a base material from an upstream roll and coating it first with a filled roofing asphalt material, then a layer of granules. The base material may be made from a fiberglass mat provided in a continuous sheet. It should be understood that the base material can be any suitable support material.

The filled roofing asphalt material is added to the continuous shingle membrane for strength and improved weathering characteristics. It should be understood that the filled roofing asphalt material can include any suitable material, preferably low in cost, durable, and resistant to fire.

The granules deposited on the composite material shield the filled roofing asphalt material from direct sunlight, offer resistance to fire, and provide texture and color to the shingle. The granules generally involve at least two different types of granules. Headlap granules are applied to the headlap portion. Headlap granules are relatively low in cost and primarily serve the functional purposes of protecting the underlying asphalt material, balancing sheet weight and preventing overlapping shingles from sticking to one another. Colored granules or other prime granules are relatively expensive and are applied to the shingle at the prime (or tab) portions. Prime granules are disposed upon the asphalt strip for both the functional purpose of protecting the underlying asphalt strip and for the purpose of providing an aesthetically pleasing appearance of the roof.

The layers of granules are generally applied with one or more granule applicators, such as granule valves, known in the art. The granules can be applied to the continuous shingle membrane in color patterns to provide the shingles with an aesthetically pleasing appearance. The granules optionally can include anti-microorganism granules, such as copper granules, to inhibit the growth of algae, fungus, and/or other microorganisms.

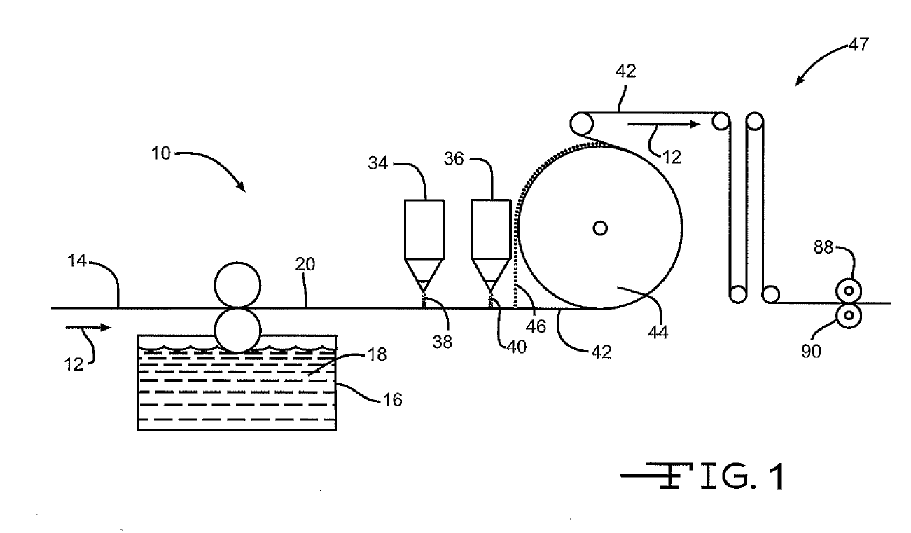

Referring now to the drawings, there is shown in FIG. 1 an apparatus 10 for manufacturing asphalt-based roofing shingles used in accordance with the invention. The illustrated manufacturing process involves passing a continuous sheet in a machine direction (indicated by an arrow 12) through a series of manufacturing operations. The sheet usually moves at a speed from about 300 feet/minute to about 800 feet/minute. However, other speeds can be used.

In a first step of the manufacturing process, a continuous sheet of shingle mat 14 is payed out from a roll (not shown). The shingle mat 14 can be any type of substrate known for use in reinforcing asphalt-based roofing shingles, such as a nonwoven web of glass fibers. The shingle mat 14 is fed through a coater 16 where a coating of asphalt 18 is applied to the shingle mat 14. The asphalt coating 18 can be applied in any suitable manner. In the illustrated embodiment, the shingle mat 14 contacts a supply of hot, melted asphalt 18 to completely cover the shingle mat 14 with a tacky coating of asphalt 18. However, in other embodiments, the asphalt coating 18 could be sprayed on, rolled on, or applied to the shingle mat 14 by other means. The asphalt can be either manufactured asphalt produced by refining petroleum or naturally occurring asphalt. The asphalt coating can include various additives and/or modifiers, such as inorganic fillers or mineral stabilizers, organic materials such as polymers, recycled streams, or ground tire rubber. Generally the filled roofing asphalt material is highly filled with a ground mineral filler material, amounting to at least about 60 percent by weight of the asphalt/filler combination. The shingle mat 14 exits the coater 16 as an asphalt-coated sheet 20. The asphalt coating 18 on the asphalt-coated sheet 20 remains hot and sticky.

As illustrated in FIG. 1, the resulting asphalt-coated sheet 20 is then passed beneath a series of granule applicators 34 and 36 for dispensing granules to an upper surface of the sheet 20. The granule applicators 34 and 36 can be of any type suitable for depositing granules onto the sheet 20. An example is a granule valve such as the granule valve disclosed in U.S. Pat. No. 6,610,147 to Aschenbeck, which is incorporated by reference in its entirety. Although two granule applicators 34 and 36 are shown in the embodiment illustrated in FIG. 1, any suitable number and configuration of granule applicators can be used.

For example, a series of two applicators can be used, wherein granule applicator 34 can be used to deposit prime granules 38 on the prime portion 30, and granule applicator 36 can be used to apply headlap granules 40 on the headlap portion 28. Applying prime granules 38 and headlap granules 40 produces a granule-covered sheet 42. In another embodiment, additional granule applicators can be used for additional granule drops, such as different colors, sharp demarcations, shadow lines, and background granules.

As shown in FIG. 1, after all the granules are deposited on the asphalt-coated sheet 20, the granule-covered sheet 42 is turned around a slate drum 44 to press the granules into the asphalt coating and to temporarily invert the granule-covered sheet 42 so that the excess granules fall off. The excess granules are recovered and applied as background granules 46 to add to the asphalt-coated sheet 20. The granule-covered sheet 42 is subsequently fed through a cooling section 47 for cooling the sheet 42. Subsequently, the sheet is fed through apparatus to be cut into individual shingles and then the shingles are stacked and packaged into bundles. Such apparatus is well known in the art.

The following description describes a laminated shingle. However, as will be appreciated by one skilled in the art, the apparatus shown in FIG. 1 for manufacturing an asphalt-based roofing shingle can be applied to either a conventional three-tab strip shingle or a laminated shingle, i.e., the headlap portion of the laminate shingle may be thinner than the tab portion. It is to be understood that, although the invention will be illustrated with reference to a particular type of laminated roofing shingle, the invention is also applicable to other types of laminated roofing shingles, and can also be used with single layer shingles, such as 3-tab shingles.

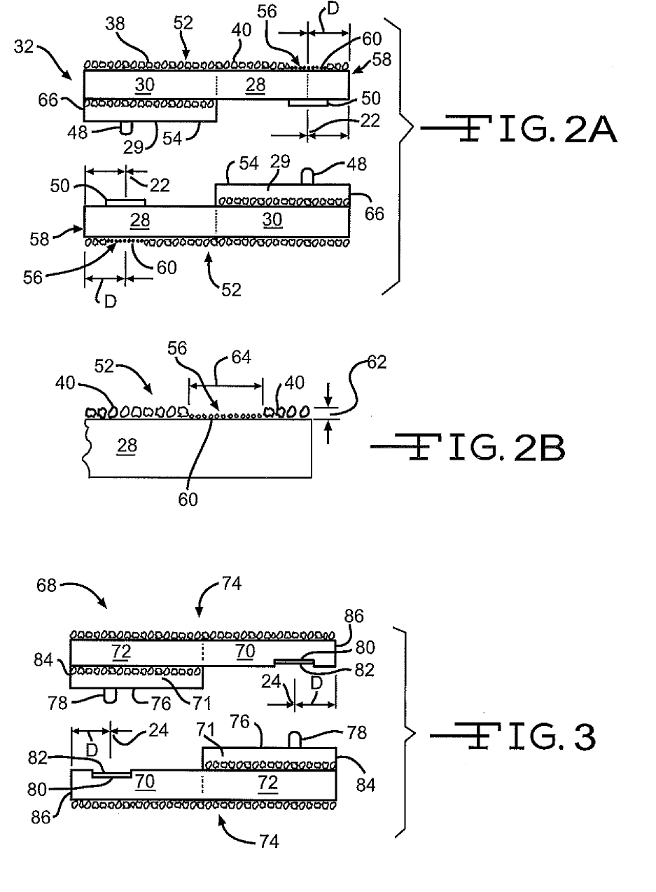

A bead of tab sealant 48, 78 (shown on a laminated shingle 32, 68 in FIGS. 2A and 3) is generally applied on the bottom of the shingle 32, 68 to hold down the tabs of the shingle when the shingles are installed on a roof. The tab sealant 48, 78 can be any material suitable for such purpose, but it is generally a modified asphalt material. Tab sealants are well known in the art. The tab sealant 48, 78 can be applied in a discontinuous or continuous manner, and in any suitable configuration. When the shingles are stacked in a bundle, the surface having the tab sealant is mated with a release surface 50, 82 (shown opposite to tab sealant in FIGS. 2A and 3) on the complementary shingle or mating shingle in the bundle. The release surface 50, 82 can be any type of material suitable for covering the tab sealant 48, 78 (prior to installation), including, but not limited to a coating, film or strip fabricated from paper, plastic, polymers, silicone or the like.

In one embodiment of the invention shown in FIG. 2A, a roofing shingle 32 includes a headlap portion 28, a tab portion 30, a granulated top surface 52, an underlay 29, and a bottom surface 54. The bottom surface 54 of the shingle includes a bead of tab sealant 48 extending horizontally across the shingle 32 when the shingle is applied to a roof (not shown). The tab sealant 48 has a thickness that causes the tab sealant to extend beyond a face of the bottom surface 54 and is configured to bond to an underlying shingle (as described above) when the shingle is applied on a roof with other similar shingles in courses. The granulated top surface 52 has a depression 56 formed in the headlap portion 28 extending horizontally across the shingle 32 when the shingle is applied to the roof. The depression 56 is spaced from a top edge 58 of the shingle 32 by a distance D (indicated by double arrows) that will allow the depression to be aligned with the tab sealant 48 of a complementary shingle when the shingles are assembled in complementary pairs, back to back in a bundle, such as bundle 92 shown in FIG. 6.

In FIG. 2A, a complementary pair of laminated roofing shingles 32 is shown positioned spaced apart to illustrate the alignment 22 of the tab sealant 48 with the depression 56 formed of fine granules 60 in the headlap portion 28 of the granulated top surface 52 of the laminated roofing shingles.

FIG. 2B is an enlarged view of the shingle of FIG. 2A showing the depression 56 formed of fine granules 60. Even though the tab sealant bead 48 does not actually touch the depression 56 or nest in the depression, the overall effect of the depression, being aligned with the tab sealant bead of the complementary shingle, is to provide protection against substantial flattening of the bead when the shingles are packaged in a bundle. The overall lessening of the thickness of the shingle by virtue of the depression 56, acts to prevent undue pressure on the tab sealant bead 48.

As shown in FIG. 2B, the depression 56 is formed of fine granules 60 having a smaller diameter than the remainder of the granules (i.e., prime granules 38 and headlap granules 40) of the granulated top surface 52. In one embodiment, the fine granules 60 have a diameter within a range of from about 0.015 inch to about 0.033 inch and the remainder of the granules has a diameter within a range of from about 0.015 inch to about 0.080 inch. It is contemplated that the middle 95% of the granule weight of the headlap and prime granules is from particles having a diameter within a range of from about 0.022 inch to about 0.068 inch.

For all the embodiments disclosed herein, it should be understood that the depression can be any size and shape, width and depth, suitable for reducing the flattening of the tab sealant 48, 78. In one embodiment, the depression 56 has a depth 62 within a range of from about 0.05 inch to about 0.50 inch and a width 64 within a range of from about 0.25 inch to about 1.50 inch. The aforementioned dimensions are applicable to the other embodiments discussed below.

It is contemplated that the tab sealant 48 is spaced from a bottom edge 66 of the shingle 32 by a distance D within a range of from about 0.25 inch to about 1.00 inch. The depression 56 can be spaced from the top edge 58 of the shingle 32 by a similar distance.

In another embodiment of the invention shown in FIG. 3, a roofing shingle 68 includes a headlap portion 70, a tab portion 72, an underlay 71, a granulated top surface 74, and a bottom surface 76. The bottom surface 76 of the shingle 68 includes a bead 78 of tab sealant extending horizontally across the shingle 68 when the shingle is applied to a roof (not shown). The tab sealant 78 has a thickness that causes it to extend beyond a face of the bottom surface 76 and is configured to bond to an underlying shingle (as described above) when the shingle is applied on a roof with other similar shingles in courses. The bottom surface 76 includes a depression 80 underneath the headlap portion 70 extending horizontally across the shingle 68 when the shingle is applied to the roof. The depression 80 is spaced from a bottom edge of the shingle by a distance D that will allow the depression to be aligned 24 with the tab sealant 78 of a complementary shingle when the shingles are assembled in complementary pairs, back to back in a bundle. In this embodiment, the depressions 80 have a release surface 82 applied to them to prevent sticking when the shingles are assembled in complementary pairs, back to back in a bundle.

It is contemplated that the tab sealant 78 is spaced from a bottom edge 84 of the shingle 68 by a distance D within a range of from about 0.25 inch to about 1.00 inch. The depression 80 can be spaced from the bottom edge 86 of the shingle 68 by a similar distance. It can be seen that alignment of the tab sealant with the depression can occur whether the depression is on the top surface 52, 74 or the bottom surface 54, 76.

In a further embodiment of the invention, a method for packaging roofing shingles in a bundle is disclosed. The method includes making shingles 32, 68 having a headlap portion 28, 70, a tab portion 30, 72, a granulated top surface 52, 74, a bottom surface 54, 76, and a tab sealant 48, 78, as shown in FIGS. 1, 2A and 3. The tab sealant 48, 78 is on the bottom surface 54, 76 of the shingles 32, 68, such that the depression 56, 80 and tab sealant extend horizontally across the shingles when the shingles are applied to a roof (not shown). The shingles 32, 68 are assembled in complementary pairs back to back in a bundle, such that the depression 56, 80 of each shingle 32, 68 is aligned with the tab sealant 48, 78 of its complementary shingle in the bundle.

Although the embodiments above show depressions 56 formed by fine granules 60, the depressions can be formed in other ways. The depressions 56, 80 can be provided by any suitable method, including, but not limited to tailoring the application of the asphalt coating to form depressions in the coating, or contacting the asphalt coating with a doctor blade or other device to form depressions in the coating. In one method of forming the depressions, the asphalt-coated sheet is subjected to a pressing operation as described below.

FIG. 4 is a schematic top view of a granule applicator 94 making two-wide shingles. The two-wide shingles have portions of fine granules 60 and headlap granules 40 deposited on the headlap portion 28 of the shingles along with prime granules 38 deposited on the tab portion 30 of the shingles. Since the fine granules 60 are of a smaller diameter than the headlap granules 40 or prime granules 38, the depression 56 is formed.

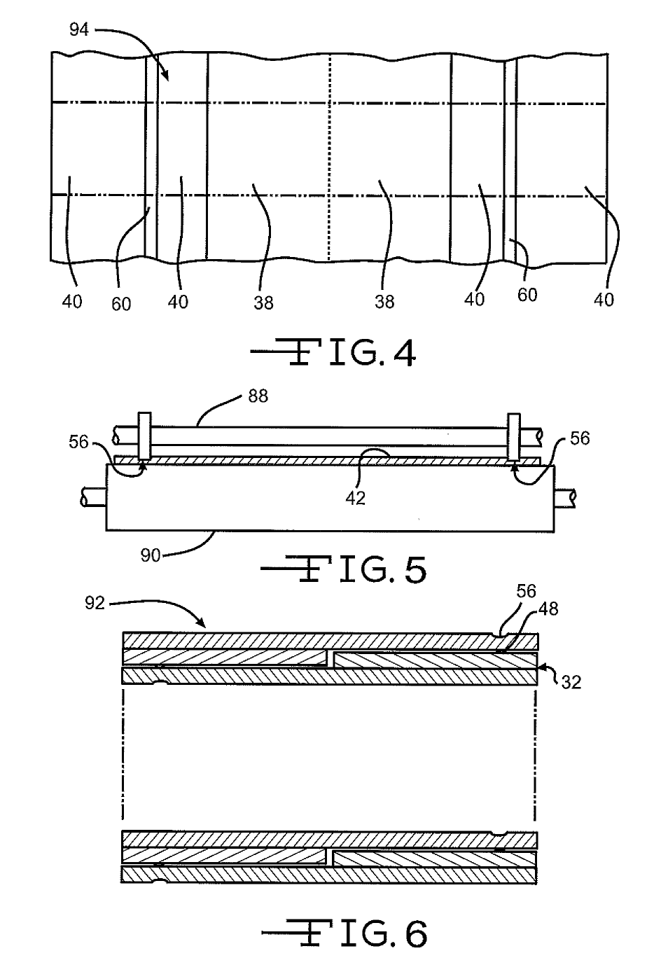

In an alternate method for making the depressions, a pressing operation is used, as shown in FIG. 5. FIG. 5 illustrates a cross-sectional, enlarged view of rollers 88, 90 shown downstream in FIG. 1 used to create the depressions 56, 80 in the granulated sheet 42. As shown in FIGS. 1 (downstream) and 5, the granulated sheet 42 can be passed through a pair of depression rollers 88, 90, which have wheels, to form the depressions 56, 80 in the shingles.

FIG. 6 is a side cross-sectional view of a bundle 92 of laminated roofing shingles 32 stacked back to back showing the alignment of the depressions 56 with the tab sealants 48 of the complementary shingles to reduce pressure exerted on the tab sealants in the bundle.

In other embodiments, making shingles includes the steps of applying asphalt to a shingle mat to form an asphalt-coated sheet, applying granules of a first diameter to a portion of the asphalt-coated sheet where the depression is to be formed, and applying granules of a larger diameter to the remainder of the asphalt-coated sheet. The granules of the first diameter (i.e., fine granules) are sized within a range of from about 0.015 inch to about 0.033 inch and the granules (i.e., headlap granules and prime granules) of the larger diameter are sized within a range of from about 0.015 inch to about 0.080 inch.

It is further contemplated that any of the headlap portions of the laminated shingle may be thinned to accomplish reduction of asphalt in desired areas. Other means to accomplish the desired thinning of the asphalt-coated sheet include, but are not limited to removal of the top coating and the use of other suitable materials than fine granules to form the depression.

It is to be understood that in other embodiments, the shingles can be stacked in the bundle either face to face or back to face. Also, in another embodiment, the tab sealant can be placed on the top surface 52 of the shingle, with the depression being placed in an appropriate area to enable protection of the tab sealant from undue pressure when the shingles are stacked in the bundle.

The principle and mode of operation of this invention have been described in certain embodiments. However, it should be noted that this invention may be practiced otherwise than as specifically illustrated and described without departing from its scope.

What is claimed is:

1. A roofing shingle having a headlap portion, a tab portion, a granulated top surface, and a bottom surface;
wherein the bottom surface of the shingle includes a bead of tab sealant extending horizontally across the shingle when the shingle is applied to a roof, the tab sealant having a thickness that causes the tab sealant to extend beyond a face of the bottom surface, the tab sealant being configured to bond to an underlying shingle when the shingle is applied on a roof with other similar shingles in courses; and
wherein the granulated top surface has a depression in the headlap portion extending horizontally across the shingle when the shingle is applied to the roof, the depression being spaced from a top edge of the shingle by a distance that will allow the depression to be aligned with the tab sealant of a complementary shingle when the shingles are assembled in complementary pairs, back to back in a bundle.

2. The roofing shingle of claim 1, wherein the depression has a depth within a range of from about 0.05 inch to about 0.50 inch.

3. The roofing shingle of claim 1, wherein the depression has a width within a range of from about 0.25 inch to about 1.50 inch.

4. The roofing shingle of claim 1, wherein the tab sealant is spaced from a bottom edge of the shingle by a distance within a range of from about 0.25 inch to about 1.00 inch, and the depression is spaced from the top edge of the shingle by a distance within a range of from about 0.25 inch to about 1.00 inch.

5. The roofing shingle of claim 1, wherein the depression is formed of fine granules having a diameter smaller than a remainder of the granules of the granulated top surface.

6. The roofing shingle of claim 1, wherein the tab sealant and depression are aligned within 10 mm of each other when the shingles are assembled in complementary pairs, back to back in a bundle.

7. The roofing shingle of claim 1, wherein the tab sealant and depression are vertically aligned with each other at center points of the tab sealant and depression when the shingles are assembled in complementary pairs, back to back in a bundle.

8. A roofing shingle having a headlap portion, a tab portion, a granulated top surface, and a bottom surface;
wherein the bottom surface of the shingle includes a bead of tab sealant extending horizontally across the shingle when the shingle is applied to a roof, the tab sealant having a thickness that causes the tab sealant to extend beyond a face of the bottom surface, the tab sealant being configured to bond to an underlying shingle when the shingle is applied on a roof with other similar shingles in courses; and
wherein the granulated top surface has a depression in the headlap portion extending horizontally across the shingle when the shingle is applied to the roof, the depression being formed of fine granules having a diameter smaller than a remainder of the granules of the granulated top surface.

9. The roofing shingle of claim 8, wherein the depression has a depth within a range of from about 0.05 inch to about 0.50 inch.

10. The roofing shingle of claim 8, wherein the depression has a width within a range of from about 0.25 inch to about 1.50 inch.

11. The roofing shingle of claim 8, wherein the tab sealant is spaced from a bottom edge of the shingle by a distance within a range of from about 0.25 inch to about 1.00 inch, and the depression is spaced from a bottom edge of the shingle by a distance within a range of from about 0.25 inch to about 1.00 inch.

12. The roofing shingle of claim 8, wherein the depression is configured to have a release surface lining an interior surface of the depression.

13. A roofing shingle having a headlap portion, a tab portion, a granulated top surface, and a bottom surface;
wherein the bottom surface of the shingle includes a bead of tab sealant extending horizontally across the shingle when the shingle is applied to a roof, the tab sealant having a thickness that causes the tab sealant to extend beyond a face of the bottom surface, the tab sealant being configured to bond to an underlying shingle when the shingle is applied on a roof with other similar shingles in courses; and
wherein the bottom surface has a depression in the headlap portion extending horizontally across the shingle when the shingle is applied to the roof, the depression being spaced from a top edge of the shingle by a distance that will allow the depression to be aligned with the tab sealant of a complementary shingle when the shingles are assembled in complementary pairs, back to back in a bundle.

14. A method for packaging roofing shingles in a bundle, the method comprising:
making shingles having a headlap portion, a tab portion, a granulated top surface, a bottom surface, and a depression, and further including a bead of tab sealant on the bottom surface, wherein the depression and tab sealant extend horizontally across the shingles when the shingles are applied to a roof; and
assembling the shingles in complementary pairs back to back in a bundle, wherein the depression of each shingle is aligned with the tab sealant of its complementary shingle in the bundle.

15. The method of claim 14, wherein the depression is on the bottom surface of the headlap portion and spaced from a bottom edge of the shingle by a distance that will allow the depression to be aligned with the tab sealant of the complementary shingle when the shingles are assembled in complementary pairs, back to back in the bundle.

16. The method of claim 14, wherein the depression is on the top surface of the headlap portion and spaced from a top edge of the shingle by a distance that will allow the depression to be aligned with the tab sealant of the complementary shingle when the shingles are assembled in complementary pairs, back to back in the bundle.

17. The method of claim 14, wherein making shingles includes:
applying asphalt to a shingle mat to form an asphalt-coated sheet;
applying granules of a first diameter to a portion of the asphalt-coated sheet where the depression is to be formed; and
applying granules of a larger diameter to a remainder of the asphalt-coated sheet.

18. The method of claim 14, wherein the granules of the first diameter are sized within a range of from about 0.015 inch to about 0.033 inch and the granules of the larger diameter are sized within a range of from about 0.015 inch to about 0.080 inch.

19. A method for making roofing shingles having a headlap portion, a tab portion, a granulated top surface, a bottom surface, and a bead of tab sealant which extends horizontally across the shingles when the shingles are applied to a roof, the method comprising:
applying asphalt to a shingle mat to form an asphalt-coated sheet;
applying fine granules to a portion of the asphalt-coated sheet, the portion being configured to extend horizontally across the shingle when the asphalt-coated sheet is made into a shingle and the shingle is installed on a roof; and
applying headlap and prime granules to a remainder of the asphalt-coated sheet, thereby forming the granulated top surface, the headlap and prime granules being larger in diameter than the fine granules, thereby forming a depression in the granulated top surface at the portion of the asphalt-coated sheet having the fine granules.

20. The method of claim 19, wherein the fine granules are sized within a range of from about 0.015 inch to about 0.033 inch and the headlap and prime granules are sized within a range of from about 0.015 inch to about 0.080 inch.

21. The method of claim 19, wherein the depression has a depth within a range of from about 0.05 inch to about 0.50 inch and a width within a range of from about 0.25 inch to about 1.50 inch.
